(19) United States
(12) Patent Application Publication
(10) Pub. No.: US 2013/0346928 A1
(43) Pub. Date: Dec. 26, 2013

(54) METHOD FOR PROTECTING RTL IP CORE

(71) Applicants: Kenli Li, Shenzhen (CN); Zhimin Zhang, Shenzhen (CN); Yan Liu, Shenzhen (CN); Zhuo Tang, Shenzhen (CN); Yun-chuan Qin, Shenzhen (CN); Degui Xiao, Shenzhen (CN)

(72) Inventors: Kenli Li, Shenzhen (CN); Zhimin Zhang, Shenzhen (CN); Yan Liu, Shenzhen (CN); Zhuo Tang, Shenzhen (CN); Yun-chuan Qin, Shenzhen (CN); Degui Xiao, Shenzhen (CN)

(73) Assignee: SHENZHEN ZHENGTONG ELECTRONICS CO., LTD., Shenzhen, Guangdong Province (CN)

(21) Appl. No.: 13/977,205

(22) PCT Filed: Jun. 25, 2011
(86) PCT No.: PCT/CN2011/076361

§ 371 Date: Sep. 11, 2013

(30) Foreign Application Priority Data
Dec. 31, 2010 (CN) 201010622157.X

(51) Int. Cl. G06F 17/50

(52) U.S. Cl. CPC G06F 17/5045
USPC 716/103

(57) ABSTRACT

A method for protecting Register Transfer Level (RTL) Intellectual Property (IP) core is provided, which converts an original RTL IP core to a target RTL IP core embedded with protection measures. The method includes: Step S1, constructing a state machine whose mode is controllable against the original RTL IP core, the state machine has a normal mode appeared corresponding to the normal function of the IP core after the entry of a correct preset secret key value and a fuzzy mode appeared corresponding to the abnormal function of the IP core after the entry of wrong secret key value; Step S2, revise the data flow of the RTL code in the original RTL IP core to obtain the fuzzy RTL code of the IP core; and Step S3: combine the state machine and the fuzzy RTL code into the targeted RTL IP core. By combining the secret key control and fuzzy data flow, the being embezzled and reverse-engineered of RTL IP core can be effectively prevented.

### CROSS-REFERENCE TO RELATED APPLICATION

This Application is a Section 371 National Stage Application of International Application No. PCT/CN2011/076361, filed Jun. 25, 2011 and published as WO 2012/088856 on Jul. 5, 2012, not in English, the contents of which are hereby incorporated by reference in their entirety.

### TECHNICAL FIELD

The invention relates to Integrated Circuit design, especially the adoption of method for protecting IP core during chip design.

### BACKGROUND ART

Since 1990s, design capacity of IC is undergoing a qualitative leap, i.e. design method changed from ASIC (Application Specific Integrated Circuits) to SoC (System on a Chip). Design method for SoC enables design work for IC to be further divided and refined. IP (Intellectual Property) core is short for integrated circuit chip core, whose purpose is to gather together a set of circuit designs with intellectual property to constitute the basic unit of the chip, for the purpose of block building during the design.

IP core can be divided into VHDL (Very-High-Speed Integrated Circuit Hardware Description Language) program which has nothing to do with the process, known as soft core and usually presented as RTL (Register-Transfer-Level) code file; and integrated circuit layout with specific circuit function is known as the hard core.

Due to more and more frequent application and transaction of IP core, some necessary technical means have appeared to assure normal transaction of IP core, for example, a trading platform which serves for IP market of IC disclosed by Chinese patent application 200810102069.X, including two subsystems-authorized application and feedback supervision; the subsystem-authorized application shall be: the IP provider uploads the encrypted IP core and basic information thereof to the transaction platform; the IP applicant searches the required IP and files an application to the IP provider; the IP provider determines whether to authorize upon the receipt of the authorization request; after being authorized, the IP applicant downloads IP core file from the platform and decrypts it to be half encryption status for use; while the subsystem-feedback supervision shall be: the system obtains the use condition of the IP and compares with the record in the authorization database; generates the use condition of IP which is inconsistent with the information of the authorization database to be report for illegal use of IP; returns the report for illegal use of IP to the IP provider; the subsystem feedback supervision has provided the interface for public network to report illegal use; in addition, it is beneficial for IP provider to make corresponding decisions against the current market condition.

To avoid the illegal use of the IP core, accordingly, there are some necessary technical means appeared to protect IP core or chips with IP core, for example a kind of IP core which can realize self-protection for data as disclosed by Chinese patent 200610072503.5; it relates to the self protective device for the data inside of the IP core, proposed for addressing the weak protectiveness of the existing IP core data. Such IP core includes the internal memory cell for IP core which is for data storage and protection. The IP internal memory cell is connected to the processor of SoC via bus, and the said IP core is also in-built with logic control unit for the generation of logic control signal. The logic control unit is connected to and controlled by the said processor, controls the logic control bit corresponding to the internal memory cell of the IP core via the generated logic control signal thereof, enabling the said internal memory cell for the IP to be under the status of locked or unlocked.

For illegal use of the IP core, there are mainly two aspects: IP embezzlement and reverse engineering. Currently, as regards the two ways, there are mainly three methods for the protection of IP core.

First: Deterrent: IP core owner may prevent IP core from being used illegally and being spread by legal deterrence, such as Patents, Copyrights and Trade secrets, etc.

Second: Authentication based: it is currently widely researched of inserting the hard-to-be removed “digital watermark” or “authentication signature” in the IP core.

Nevertheless, watermark technology only attests the possession of IP core, while embezzlement of IP core can not be prevented; moreover, currently most of commercial IP cores are distributed in the form of RTL code file.

Third: Fuzzy technology based: IP core supplier always encrypts RTL IP core with encryption technology, so as to affect the readability of the code. Therefore, code after being encrypted is difficult to suffer from reverse engineering. However, use of encryption technology for IP enables the flexibility of the system to be weak, and functions are difficult to be expanded. Besides, generally speaking, the code after being encrypted can't effectively avoid the embezzlement of IP core either due to the requirement of specific operation platform: generally, multiple IP cores are required to be used during the design of large modern SoC, while it is often difficult to meet the requirement of customized operation platform for multiple IP cores, moreover, it is also hoped by the SoC developers that sufficient flexibility shall be provided by IP core.

In addition, software fuzzy is also a means to protect IP core from being reverse-engineered. Nevertheless, method for the protection of software can't be applied to IP core directly due to the requirement of different restrictions by the software fuzzy, such as code size, execution time and the like.

As compared to firm IP core and/or hard IP core, RTL IP core has good transparency and portability. Therefore, it is extremely difficult to protect RTL IP core from being embezzled and reverse-engineered.

### INVENTION CONTENTS

In view of the above-described problems, the aim of the invention are to avoid defects in the prior art and to provide a method which can effectively prevent the embezzlement and reverse engineering of the RTL IP core.

Technical means adopted by the invention for solving the aforementioned technical issues includes the put forward of a method for protecting RTL IP core, so as to convert the original RTL IP core into targeted RTL IP core with in-built protective measures, which shall include:

Step S1, constructing a state machine whose mode is controllable against the original RTL IP core, the state machine has a normal mode appeared corresponding to the normal function of the IP core after the entry of a correct preset secret key value and a fuzzy mode appeared corresponding to the abnormal function of the IP core after the entry of wrong secret key value;

Step S2, Revise the data flow of the RTL code in the original RTL IP core to obtain the fuzzy RTL code of the IP core; and

Step S3: Combine the state machine and the fuzzy RTL code into the targeted RTL IP core.

The state machine of the invention is constructed utilizing the internal principal register of the IP core.

Operating mode of the state machine is determined by the value of the extension digit of the principal register.

The secret key value is entered for the state machine, only correct preset secret key value is entered will the value of the extension digit for the principal register be correct and can the state machine work normally. After entering normal mode, value of the extension digit for the principal register will stay at normal mode value all the way till the reset signal takes effect. If the secret key value is entered wrong, value of the extension digit for the principal register will be the value of abnormal mode, and the sate machine can only enter fuzzy mode.

Such method for the invention can also include Step S0: analyze the RTL code of the original RTL IP core and constitute an RTL code tree.

Step S1 of the invention is specifically: rewriting the code of the assignment statement relating to the principal register according to the RTL code tree;

Modify the input and output signal relating to the principal register apart from IP core input and output signal into the signal whose bit width is equal to that for the principal register;

Modify the branch of the RTL code tree to obtain the fuzzy RTL code tree.

The process of modifying the branch of the RTL code tree is specifically: adding control statement in front of the selected assignment statement, so as to enable the execution of assignment statement to be conditional. When and only when the set secret key value is entered correctly can the state machine select correct branch from the fuzzy RTL code tree.

Step S2 of the invention is specifically: translation of fuzzy RTL code tree into RTL code.

The said translation of fuzzy RTL code tree into RTL code is carried out in depth-first way.

Step S3 of the invention is specifically: synthesize the fuzzy RTL code, verify functional concordance of the code before and after blur, and matching ratio shall meet the designed requirements. Then, assess the fuzzy effect via area factor, if qualified upon assessment, the fuzzy RTL code shall be recognized.

Compared with the existing technology, the method for protecting RTL IP core of the invention combines secret key control and fuzzy data flow, which can effectively prevent the RTL IP core from being embezzled and reverse-engineered.

### DESCRIPTION OF FIGURES

FIG. 1 is the flow chart of the embodiment for the method for protecting the RTL IP core of the invention.

FIG. 2 is the schematic diagram of the embodiment for the method for protecting the RTL IP core of the invention.

### MODE OF CARRYING OUT THE INVENTION

To further illustrate the principle and structure of the invention, the invention is further described in detail in accordance with the preferable embodiments shown in the figures.

As to the method for protecting RTL IP core of the invention, based on the combination of secret key control and fuzzy data flow, it includes: constructing a state machine for the internal RTL code whose mode is controllable, enabling the operation mode of IP core to be of normal mode and a variety of simulated modes; entering normal operation mode by entering correct secret key, thus to prevent the IP core from being illegally used without authorization; realizing fuzzy code effect by modifying the data flow of RTL code, mainly the modification of case, if, assign and other statements and set up of interconnection between modules, etc., thus to assure that a RTL code with chaotic structure is obtained under the condition of functional concordance, consequently, reverse engineering of IP core can be prevented effectively, thereby, protective capacity for the code is improved significantly.

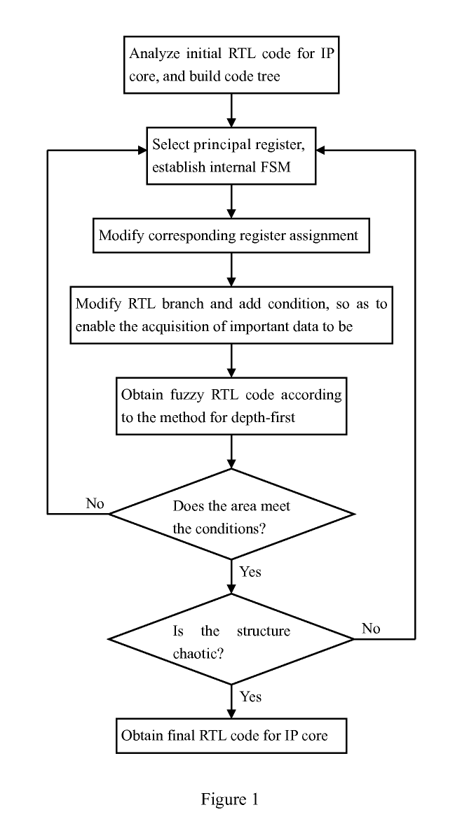

As is shown in FIG. 1, method for protecting RTL IP core of the invention roughly includes the following steps:

Step S0: Analyze RTL code and construct an RTL code tree, i.e. present RTL code in the form of a structure tree taking the top module of RTL code as root node in accordance with the hierarchical structure of the code.

Step S1: Construct internal FSM (finite state machine). Select in-built principal register of IP core as the control register of FSM state, expand the bit width of the control register, and control the state transition of FSM with the value of the extension digit; and rewrite the corresponding code in the related assignment statements of the control register according to the RTL code tree.

Meanwhile, modify input and output signal related t the register (apart from input and output signal of the IP core) into corresponding width.

Modify the branch of RTL code tree. Add control statements before some relatively important assignment statements, for instance increase of judgment condition, enabling the execution of the statements to be conditional. Only when the given secret key is entered correctly can correct execute statement be accessed, i.e. to modify the branch of the RTL code tree.

Step S2: Generation of fuzzy RTL code: after fuzzy RTL code tree is obtained, convert the RTL code tree into RTL code according to the way of depth-first.

S3: Synthesize the fuzzy RTL code verify the functional concordance of the code before and after blur with the Formality of Synopsys, the lower the match ratio the better the fuzzy effect, therefore, the match ratio shall be lower than a set value. If qualified upon verification, assess its area with the VHDL Encounter RTL complier supported by Cadence, if the area is within the acceptable range, the algorithm shall be completed, otherwise, return to Step S1.

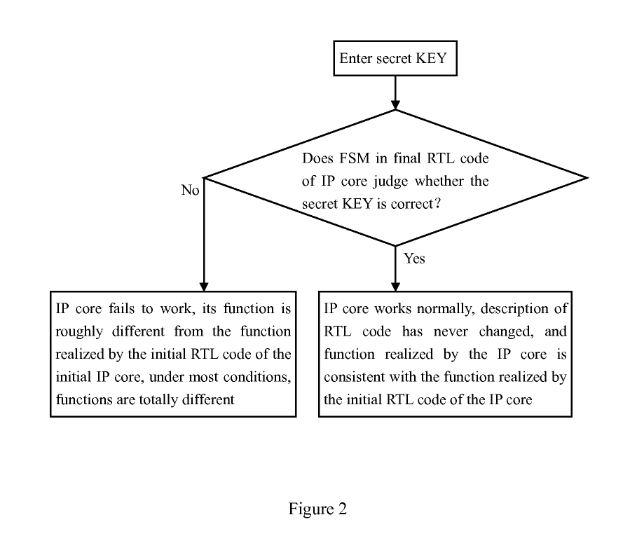

As shown in FIG. 2, the invention method mainly proposes a kind of RTL code protection technology regarding that most of commercial IP cores are released with RTL code, combining secret key technology and fuzzy data flow structure. By means of mode state machine control, embezzlement of IP core can be avoided perfectly. Only when the given secret keys entered correctly can the system enter normal operation mode, and function of the IP core at this moment is consistent with that of the initial IP core, code description has never been changed; after wrong secret key is entered, IP fails to work, whose function is almost different with the function of the initial IP core, under most circumstances, functions are identical. Such method can be realized easily, and RTL code can be protected. By dimming the data flow of the RTL code and disruption of data structure, program structure will be messy and difficult to be clarified, thus, reverse engineering of the system code can be effectively prevented; in addition, specific platform is not required for the invention method, so, it is applicable to SoC development, FPGA system design and development of various HDLS systems with superior universality. What is required to be noted is that secret key is entered for the state machine, only when correct secret key is entered and extension digit value for the principal register is correct, can it enter correct mode. After entering normal mode, value for the extension digit of the principal register will stay at normal mode value all the way till the reset signal takes effect; for fuzzy mode, value for the extension digit of the principal register is impossible to be normal value. For different IP cores, the preset secret keys are also different, and secret keys for IP cores of different fuzzy degrees are also different, preferentially, secret key which is a series shall have better security. Secret key can also be a numerical value whose security shall be worse.

Analyze from time complexity of algorithm, reliability and robustness of fuzzy strategy for the invention method are reflected by the use quantity of the principal register for FSM and control signal. For instance, such condition which may be considered is that: n state transition statements are placed in an FSM whose modes are controllable (in the invention, n is extension register), correspondingly, the inserted blocking and non-blocking assignment statements are assignment statements of fuzzy modes which are greater than or equal to the number of key series, and secret key series are often hidden in these assignment statements;

Moreover, there are N blocking/non-blocking assignments (in the invention, N is all the blocking/non-blocking assignment statements), which is the sum of blocking/non-blocking assignment statements of fuzzy state and normal state.

Then, for the attacker, first of all, state transition statement placed into FSM must be pinpointed accurately, and there are

$${\sum }_{k = 1}^{n} ( \begin{matrix}N \\ k\end{matrix} )$$

possibilities for the process. Secondly, for each selection, there are K! possibilities (so as to enable the initial secret key series to b correct). Therefore, the attacker must try

$${\sum }_{k = 1}^{n} ( ( \begin{matrix}N \\ k\end{matrix} ) \cdot k ! )$$

possibilities. Meanwhile, the attacker must find out the control signal for the mode, supposing M as all the assignment statements for the whole IP core, including blocking, non-blocking and data floe assignment, supposing m as the dimension to modify the signal pool, the attacker must select m modified signals correctly from M signals, i.e.

$$( \begin{matrix}M \\ m\end{matrix} )$$

possibilities. Combining these two factors, the following expression is obtained:

$${M}_{obf} = \frac{1}{{\sum }_{k = 1}^{n} ( ( \begin{matrix}N \\ k\end{matrix} ) \cdot k ! ) \cdot ( \begin{matrix}M \\ m\end{matrix} )}$$

M_{obf} here represents complexity, the less the computational times, the greater will the M_{obf} be, indicating easier cracking, and vise versa.

It is thus clear that the design objective is the smaller the M_{obf} the better. For instance, in a section of RTL code, N=30, M=100, parameter n=3, m=20 are taken, then M_{obf}=7.36×10 m26. In other words, if the attacker intends to complete reverse engineering, he must try 1027 possibilities, while in actual RTL code, value for n and M are often great, thereby, reverse engineering is more difficult to e realized.

What shall be noted is that criterion for whether the structure of the fuzzy code is chaotic shall firstly be the above M_{obf} element, the smaller the value, the more will the crack time, and the better dim; the other shall be verification of functional concordance for the code before and after dimming with Formality from Synopsys, the lower the match ratio the better will the fuzzy effect.

Compared with the existing technology, although it is also the lock of IP core for the invention, however, it is different from the way that a control module is added to the outside of the IP core or to the head of the IP core interior for the existing technology, for the invention, the control module is added inside of the IP core, moreover, such lock is realized by expending the IP core in-built register (principal register), in addition, whether IP core has output correct vale and maintain the mode where the state machine stays is judged through extension digit, thereby, the attacker is difficult to find the lock and more difficult to crack, accordingly, IP will also become more secure.

The above is only the preferable embodiment of the invention, but not the limitation of the protection scope of the invention, therefore, the equivalent structural change made applying the instructions of the invention and the contents of the attached drawings are all included in the protection scope of the invention.

1-10. (canceled)

11. A method for protecting RTL level IP core, for converting an original RTL IP core into an in-built targeted RTL IP core with protective measures, features that the method includes:
Step S1, constructing a state machine whose mode is controllable against the original RTL IP core, the state machine has a normal mode appeared corresponding to the normal function of the IP core after the entry of a correct preset secret key value and a fuzzy mode appeared corresponding to the abnormal function of the IP core after the entry of wrong secret key value;
Step S2, revise the data flow of the RTL code in the original RTL IP core to obtain the fuzzy RTL code of the IP core; and
Step S3, combine the state machine and the fuzzy RTL code into the targeted RTL IP core.

12. A method for protecting RTL level IP core according to claim 1, wherein the state machine is constructed by utilizing the internal principal register of the IP core.

13. A method for protecting RTL level IP core according to claim 2, wherein operation mode of the state machine is determined by the value of the extension digit of the principal register.

14. A method for protecting RTL level IP core according to claim 3, wherein the secret key value is entered for the state machine, only when correct preset secret key value is entered, will the value of the extension digit for the principal register be correct and can the state machine enter normal mode, after entering normal mode, value for the extension digit of the principal register will stay at normal mode value all the way till the reset signal takes effect; if wrong secret key value is entered, value for the extension digit of the principal register shall be value of abnormal mode, thus, the state machine can only access fuzzy mode.

15. A method for protecting RTL level IP core according to claim 1, wherein the method also includes Step S0, analyzing the RTL code of the original RTL IP core and constitute an RTL code tree.

16. A method for protecting RTL level IP core according to claim 5, wherein Step S1 specifically includes, rewriting the code of the assignment statement related to the principal register according to the code tree;
Modify the input and output signal relating to the principal register apart from IP core input and output signal into the signal whose bit width is equal to that for the principal register;
Modify the branch of the RTL code tree to obtain the fuzzy RTL code tree.

17. A method for protecting RTL level IP core according to claim 6, wherein the process of modifying the branch of the RTL code tree is specifically, adding control statement in front of the selected assignment statement, so as to enable the execution of the assignment statement to be conditional, when and only when the set key value is entered correctly can the state machine select correct branch from the fuzzy RTL code tree.

18. A method for protecting RTL level IP core according to claim 6, wherein Step S2 specifically includes, translating the fuzzy RTL code tree into RTL code.

19. A method for protecting RTL level IP core according to claim 8, wherein the said translation of fuzzy RTL code tree into RTL code is carried out in accordance with depth-first.

20. A method for protecting RTL level IP core according to claim 1, wherein Step S3 includes, synthesizing the fuzzy RTL code, verify the functional concordance of the code before and after dimming, the match ratio is required to reach the set requirements, then assess the fuzzy effect via area factor, if qualified upon assessment, the fuzzy RTL code shall be recognized.

21. A method for protecting RTL level IP core according to claim 2, wherein the method also includes Step S0, analyzing the RTL code of the original RTL IP core and constitute an RTL code tree.

22. A method for protecting RTL level IP core according to claim 11, wherein Step S1 specifically includes, rewriting the code of the assignment statement related to the principal register according to the code tree;
Modify the input and output signal relating to the principal register apart from IP core input and output signal into the signal whose bit width is equal to that for the principal register;
Modify the branch of the RTL code tree to obtain the fuzzy RTL code tree.

23. A method for protecting RTL level IP core according to claim 12, wherein the process of modifying the branch of the RTL code tree is specifically, adding control statement in front of the selected assignment statement, so as to enable the execution of the assignment statement to be conditional, when and only when the set key value is entered correctly can the state machine select correct branch from the fuzzy RTL code tree.

24. A method for protecting RTL level IP core according to claim 12, wherein Step S2 specifically includes, translating the fuzzy RTL code tree into RTL code.

25. A method for protecting RTL level IP core according to claim 14, wherein the said translation of fuzzy RTL code tree into RTL code is carried out in accordance with depth-first.

26. A method for protecting RTL level IP core according to claim 3, wherein the method also includes Step S0, analyzing the RTL code of the original RTL IP core and constitute an RTL code tree.

27. A method for protecting for RTL level IP core according to claim 16, wherein Step Si specifically includes, rewriting the code of the assignment statement related to the principal register according to the code tree;
Modify the input and output signal relating to the principal register apart from IP core input and output signal into the signal whose bit width is equal to that for the principal register;
Modify the branch of the RTL code tree to obtain the fuzzy RTL code tree.

28. A method for protecting RTL level IP core according to claim 17, wherein the process of modifying the branch of the RTL code tree is specifically, adding control statement in front of the selected assignment statement, so as to enable the execution of the assignment statement to be conditional, when and only when the set key value is entered correctly can the state machine select correct branch from the fuzzy RTL code tree.

29. A method for protecting RTL level IP core according to claim 17, wherein Step S2 specifically includes, translating the fuzzy RTL code tree into RTL code.

30. A method for protecting RTL level IP core according to claim 19, wherein the said translation of fuzzy RTL code tree into RTL code is carried out in accordance with depth-first.

31. A method for protecting RTL level IP core according to claim 4, wherein the method also includes Step S0, analyzing the RTL code of the original RTL IP core and constitute an RTL code tree.

32. A method for protecting RTL level IP core according to claim 21, wherein Step S1 specifically includes, rewriting the code of the assignment statement related to the principal register according to the code tree;
Modify the input and output signal relating to the principal register apart from IP core input and output signal into the signal whose bit width is equal to that for the principal register;
Modify the branch of the RTL code tree to obtain the fuzzy RTL code tree.

33. A method for protecting RTL level IP core according to claim 22, wherein the process of modifying the branch of the RTL code tree is specifically, adding control statement in front of the selected assignment statement, so as to enable the execution of the assignment statement to be conditional, when and only when the set key value is entered correctly can the state machine select correct branch from the fuzzy RTL code tree.

34. A method for protecting RTL level IP core according to claim 22, wherein Step S2 specifically includes, translating the fuzzy RTL code tree into RTL code.

35. A method for protecting RTL level IP core according to claim 24, wherein the said translation of fuzzy RTL code tree into RTL code is carried out in accordance with depth-first.
